(19) United States
(12) Patent Application Publication
(10) Pub. No.: US 2009/0103961 A1
(43) Pub. Date: Apr. 23, 2009

(54) IMAGE FORMING APPARATUS AND IMAGE FORMING METHOD THEREOF

(75) Inventors: Jung-woo Son, Seoul (KR); Gun-ho Kim, Seoul (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/236,625

(22) Filed: Sep. 24, 2008

(30) Foreign Application Priority Data
Oct. 19, 2007 (KR) 2007-105787

(51) Int. Cl. G03G 15/00

(52) U.S. Cl. 399/397

(57) ABSTRACT

An image forming apparatus and an image forming method thereof. The image forming apparatus includes an image forming part which forms a color image on a printing medium, a pickup roller which picks up the printing medium, and a controller which controls the pickup roller to try to pick up the printing medium if image forming for a first color among a plurality of colors is completed, and controls the image forming part to form an image corresponding to a second color among the plurality of colors after trying to pick up the printing medium.

### CROSS-REFERENCE TO RELATED APPLICATIONS

This application claims priority under 35 U.S.C. §119(a) from Korean Patent Application No. 10-2007-0105787, filed on Oct. 19, 2007 in the Korean Intellectual Property Office, the disclosure of which is incorporated herein in its entirety by reference.

### BACKGROUND OF THE INVENTION

1. Field of the Invention

The present general inventive concept relates to an image forming apparatus and image forming method thereof, and more particularly, to an image forming apparatus which controls a time to pick up a printing medium, and an image forming method thereof.

2. Description of the Related Art

In general, an image forming apparatus forms an image on a printing medium on the basis of printing data. Particularly, in a color image forming apparatus, light is scanned to a photosensitive body electrified at a certain electric potential to form an electrostatic latent image, and then, a developer of a predetermined color is applied to the electrostatic latent image to form a developer image. The developer image is transferred and fused onto a printing medium to form a color image.

The color image forming apparatus may be classified into a single pass type in which a plurality of light scan units and a plurality of photosensitive bodies are provided corresponding to a plurality of colors and a multi pass type in which a single light scan unit and a single photosensitive body are provided corresponding to a plurality of colors.

In the case of the multi pass type, the single light scan unit scans light corresponding to a plurality of colors, for example, yellow (Y), magenta (M), cyan (C) and black (K), and images formed on the photosensitive body are sequentially transferred to an intermediate transfer medium.

A printing medium is picked up by a pickup roller before all the images are transferred to the intermediate transfer medium. An image on the intermediate transfer medium is transferred to the printing medium by a transfer roller. The image on the printing medium is fused by a fusing roller to complete a final color image.

However, in the conventional image forming apparatus, time when the printing medium is picked up is not significantly considered, and in general, the printing medium is picked up while an image is formed on the photosensitive body or the intermediate transfer medium. Thus, the printing medium may be picked up during image forming, which may cause a so-called jitter phenomenon to an image due to vibrations at the time of pickup.

Further, in the case that pickup of the printing medium is failed, since time when the printing medium is re-picked up is not also significantly considered, re-pickup is performed immediately after the failure of pickup. In this case, the jitter phenomenon may double, and noises which a user feels may increase due to driving of the pickup roller.

### SUMMARY OF THE INVENTION

The present general inventive concept provides an image forming apparatus to pick up a printing medium while an image is not formed to thereby minimize jitter phenomenon, and an image forming method thereof.

The present general inventive concept also provides an image forming apparatus which can decrease noises which a user feels, and an image forming method thereof.

The present general inventive concept also provides an image forming apparatus to re-pick up even after completion of an image in a case of failure of picking up a printing medium, and an image forming method thereof.

Additional aspects and utilities of the present general inventive concept will be set forth in part in the description which follows and, in part, will be obvious from the description, or may be learned by practice of the present general inventive concept.

The foregoing and/or other aspects of the present general inventive concept can be achieved by providing an image forming method in an image forming apparatus comprising an image forming part which forms a color image on a printing medium, including forming an image corresponding to a first color among a plurality of colors, picking up the printing medium after image forming for the first color is completed, and forming an image corresponding to a second color among the plurality of colors after picking up the printing medium.

The image forming part may include a photosensitive body and an intermediate transfer medium, and the image forming may include exposing the photosensitive body; electrifying a surface of the photosensitive body; developing an electrostatic latent image formed on the photosensitive body; and transferring the developed image onto the intermediate transfer medium.

The picking up the printing medium may include re-picking up the printing medium after the image forming for the second color is completed, if the printing medium is not picked up.

The picking up the printing medium may include trying to re-pick up the printing medium, if the printing medium is not picked up after the image forming for all the plurality of colors is completed.

The re-picking up the printing medium may include stopping cleaning the image during trying to re-pick up the printing medium.

The intermediate transfer medium may idly rotate during re-picking up the printing medium.

The number of the re-picking up may be selected by a user. Here, the number of the re-picking up may be selected through a user interface of at least one of the image forming apparatus, a driver of the image forming apparatus, and an application for use in writing a document.

The plurality of colors may include yellow (Y), magenta (M), cyan (C) and black (K).

The image forming may include forming the image in a multi-pass method.

The foregoing and/or other aspects of the present invention can be also achieved by providing an image forming method of forming a color image on a printing medium, the method including forming an image corresponding to a first color among a plurality of colors, forming an image corresponding to a second color among the plurality of colors, and picking up the printing medium in a non-image section between the image forming for the first color and the image forming for the second color.

The foregoing and/or other aspects of the present invention can be also achieved by providing an image forming apparatus, including an image forming part which forms a color image on a printing medium, a pickup roller which picks up the printing medium, and a controller which controls the pickup roller to pick up the printing medium if image forming for a first color among a plurality of colors is completed, and controls the image forming part to form an image corresponding to a second color among the plurality of colors after picking up the printing medium.

The image forming part may include a light scan unit, a photosensitive body and an intermediate transfer medium, and the image forming may include exposing the photosensitive body by the light scan unit, electrifying a surface of the photosensitive body, developing an electrostatic latent image formed on the photosensitive body, and transferring the developed image to the intermediate transfer medium.

The controller may control the pickup roller to re-pick up the printing medium after image forming for the second color is completed, if the printing medium is not picked up.

The controller may control the pickup roller to re-pick up the printing medium, if the printing medium is not picked up after image forming for all the plurality of colors is completed.

The image forming apparatus may further include a cleaning member which cleans the image, and the controller may control the cleaning member not to clean the image during re-picking up the printing medium.

The intermediate transfer medium may idly rotate during trying to re-pick up the printing medium.

The plurality of colors may include yellow (Y), magenta (M), cyan (C) and black (K).

The image forming part may form the image in a multi pass method.

The foregoing and/or other aspects of the present invention can be also achieved by providing an image forming apparatus, including an image forming part which forms a color image on a printing medium, a pickup roller which picks up the printing medium, and a controller which controls the pickup roller to try to pick up the printing medium in a non-image section between image forming for a first color among a plurality of colors and image forming for a second color among the plurality of colors.

The foregoing and/or other aspects of the present invention can be also achieved by providing an image forming apparatus including an image forming part to form a plurality of color images to form a multi color image, a pickup unit to pick up a printing medium, and a controller to control the pickup unit not to pick up the printing medium when the image forming part forms each of the plurality of color images.

The image forming apparatus may further include a feeding roller to feed the picked up printing medium, and the controller may control the feeding roller not to feed the picked up printing medium until the multi color image is formed from the plurality of color images.

The controller may control the picked up printing medium to be in a holding state in a period until the multi color image is formed.

The period may vary according to a time taken to pick up the printing medium from a time when a first color image of the plurality of color images is completed.

The controller may control the pickup unit to repeat a process to pick up the printing medium between image forming processes of the image forming part.

The number of image forming processes of the image forming part may be equal to or greater than the number of processes of the pickup unit to pick up the printing medium.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a block diagram illustrating an image forming apparatus according to an exemplary embodiment of the present general inventive concept;

FIG. 2 schematically illustrates the image forming apparatus of FIG. 1;

FIG. 3 is a flowchart illustrating an image forming method according to an exemplary embodiment of the present general inventive concept;

FIGS. 4A and 4B are flowcharts illustrating an image forming method according to another exemplary embodiment of the present general inventive concept; and

FIG. 5 illustrates a user interface of the image forming apparatus according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The exemplary embodiments are described below so as to explain the present general inventive concept by referring to the figures.

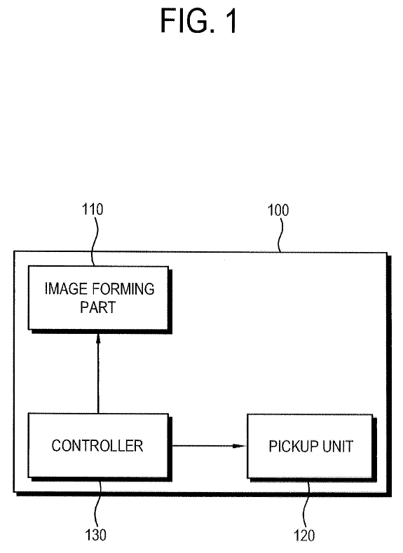

Referring to FIG. 1, an image forming apparatus 100 according to an exemplary embodiment of the present general inventive concept includes an image forming part 110, a pickup unit 120, and a controller 130. The image forming apparatus 100 may be provided as a multi pass type in which the image forming part 110 includes a single light scan unit and a single photosensitive body.

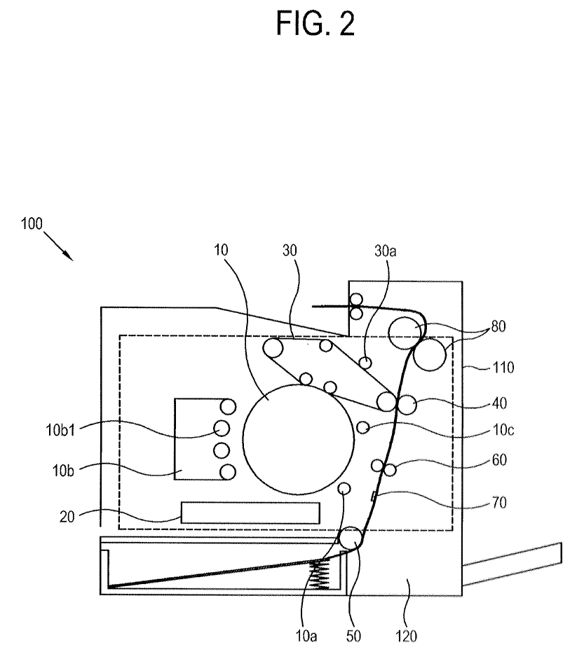

The image forming part 110 forms an image on a printing medium on the basis of printing data. As illustrated in FIG. 2, the image forming part 110 includes a photosensitive body 10, a light scan unit 20, an intermediate transfer medium 30, a transfer roller 40, a registration member 60, and a registration sensor 70.

The photosensitive body 10 employs a photosensitive drum on which a light conductive material is coated and rotates so that a linear velocity of a circumferential surface thereof is equal to a feeding velocity of the intermediate transfer medium 30. Adjacent to the photosensitive body 10 is provided an electrifying roller 10a which contacts the photosensitive body 10 and electrifies the surface of the photosensitive body 10 at a uniform electric potential. If the photosensitive body 10 is electrified at a negative electric potential by the electrifying roller 10a, the light scan unit 20 scans light onto the photosensitive body 10 to form an electrostatic latent image. A developing unit 10b may have a developing roller 10b1 to spread a developer onto the electrostatic latent image on the photosensitive body 10 to form a developer image. Then, the developer image is transferred to the intermediate transfer medium 30. A cleaning roller 10c cleans the photosensitive body, and a cleaning member 30a is provided to clean the developer image on the intermediate transfer medium 30.

The pickup roller 50 of the pickup unit 120 picks up a printing medium to the image forming part 110. The registration sensor 70 senses whether or not the printing medium is picked up by the pickup roller 50 of the pickup unit 120. If the pickup of the printing medium is failed, the pickup roller 50 of the pickup unit 120 may start a process to re-pick up the printing medium under the control of the controller 130.

The controller 130 controls the pickup roller 120 to start a process to pick up the printing medium if image forming corresponding to a first color among a plurality of colors is completed. After starting the process to pick up the printing medium, that is, when the printing medium is picked up by the pickup unit 120, the controller 130 controls the image forming part 110 to form an image corresponding to a second color among the plurality of colors. Here, the plurality of colors may include yellow (Y), magenta (M), cyan (C) and black (K). The first color may include Y, C and C; and the second color may include M, C and K.

Here, the printing medium has a leading edge portion, a trailing edge portion, and a middle portion in a pickup direction. The controller 130 may determine that the printing medium is picked up when at least the leading edge portion and a portion of the middle portion of the printing medium is picked up or sensed by the registration sensor 70. It is possible that it is determined that the printing medium is picked up when the leading edge portion and a portion of the middle portion of the printing medium between the leading edge portion and a center of the printing medium is picked up by the pickup roller 50 and lifted up from a stack of sheets of paper stored in a paper cassette of the pickup unit 120.

The image forming process corresponding to the plurality of colors may include a light exposing stage in which the photosensitive body 10 is exposed by the light scan unit 20 to form an electrostatic latent image, a developing stage in which a developer is developed onto the electrostatic latent image on the photosensitive body 10 to form a developer image, and a transferring stage in which the developer image is transferred from the photosensitive body 10 to the intermediate transfer medium 30.

After the image forming process for the first color is completed, the controller 130 controls the pickup roller 120 to pick up the printing medium to the image forming part 110 before image forming for the second color. For example, in a non-image section before image forming for the color M as the second color and after image forming for the color Y as the first color, the controller 130 controls the pickup roller 120 to pick up the printing medium to the image forming part 110, thereby minimizing the jitter phenomenon.

When the printing medium is not picked up within a predetermined time, the controller 130 controls the pickup roller 120 to re-pick up the printing medium to the image forming part 110 before image forming for the color C as a third color and after image forming for the color M as the second color. If the printing medium is not picked up by the re-picking up, the controller 130 may control the pickup roller 120 to re-pick up the printing medium to the image forming part 110 before image forming for the color K as a fourth color and after image forming for the color C as the third color.

For example, assuming that the image forming apparatus 100 is capable of performing color image forming at a speed of 5ppm, image forming for every color is completed per every 3 seconds. Thus, if picking up the printing medium is failed after image forming for the color Y is completed, the controller 130 tries to re-pick up the printing medium after image forming for the color Y, that is, after 3 seconds. Thus, noises which a user feels can be decreased compared with the conventional image forming apparatus which tries to continuously pick up the printing medium if pickup of the printing medium is failed.

On the other hand, if the printing medium is not picked up even after image forming for the color K is completed, that is, even after image forming for all the colors is completed, the controller 130 may control the pickup roller 120 to continuously re-pick up the printing medium at the same time when the intermediate transfer medium 30 rotates. In this case, the controller 130 may control the cleaning member 30a not to clean an image on the intermediate transfer medium 30. Thus, it is possible to increase the number of repeated processes to re-pick up the printing medium, to thereby decrease probabilities of a paper jam error.

When the printing medium is picked up between forming images of colors, the picked-up printing medium is in a waiting mode not to be fed to the intermediate transfer medium 30 and is changed to a feeding mode to be fed to the intermediate transfer medium 30 by the registration roller 60, i.e., a feeding roller, when the image of a final color of the colors are formed. It is possible that the picked-up printing medium is in a picking-up state after being picked up by the pickup unit 120 such that the picked-up printing medium is not fed to the intermediate transfer medium 30. Accordingly, a period of the waiting mode varies according to when the printing medium is picked up, that is, between first and second image forming, between second and third image forming, between the third and fourth image forming, or after fourth image forming.

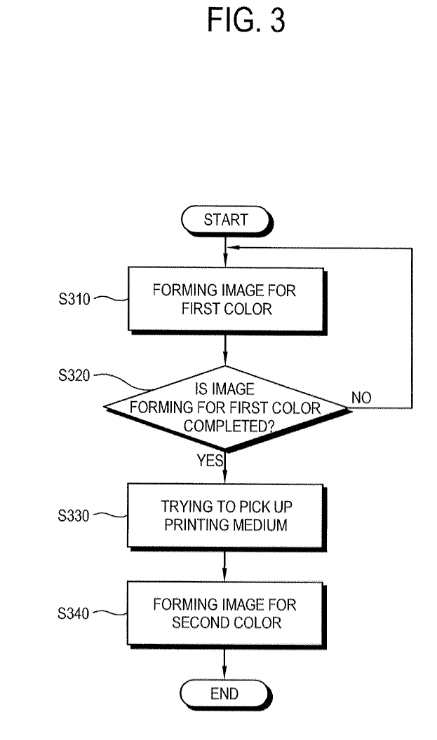

Hereinafter, an image forming method of the image forming apparatus 100 according to an exemplary embodiment of the present general inventive concept will be described with reference to FIG. 3.

Referring to FIGS. 1, 2, and 3, the controller 130 controls the image forming part 110 to form an image corresponding to a first color among a plurality of colors at operation S310.

Then, the controller 130 determines whether image forming for the first color is completed at operation S320.

If it is determined that the image forming for the first color is completed, the controller 130 controls the pickup roller 120 to pick up a printing medium at operation S330.

Here, the operation S330 may include re-picking up the printing medium after image forming for a second color is completed; and may further include re-picking up the printing medium if the printing medium is not picked up after image forming for all colors is completed. In this case, it is desirable that the image on the intermediate transfer medium is not cleaned by the cleaning member 60.

Next, the controller 130 controls the image forming part 110 to form an image corresponding to the second color after trying to pick up the printing medium at operation S340.

In this way, it is possible minimize occurrence of the jitter phenomenon and minimize noises which a user feels.

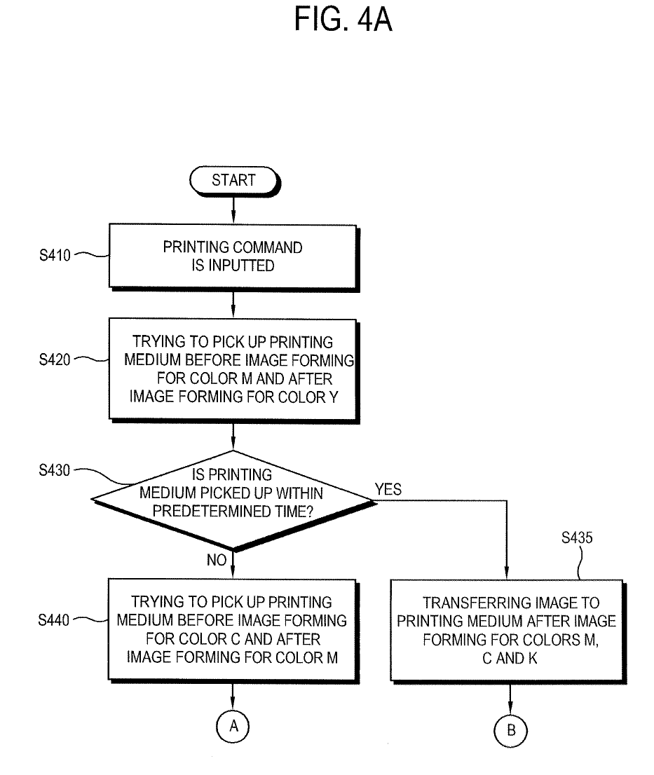

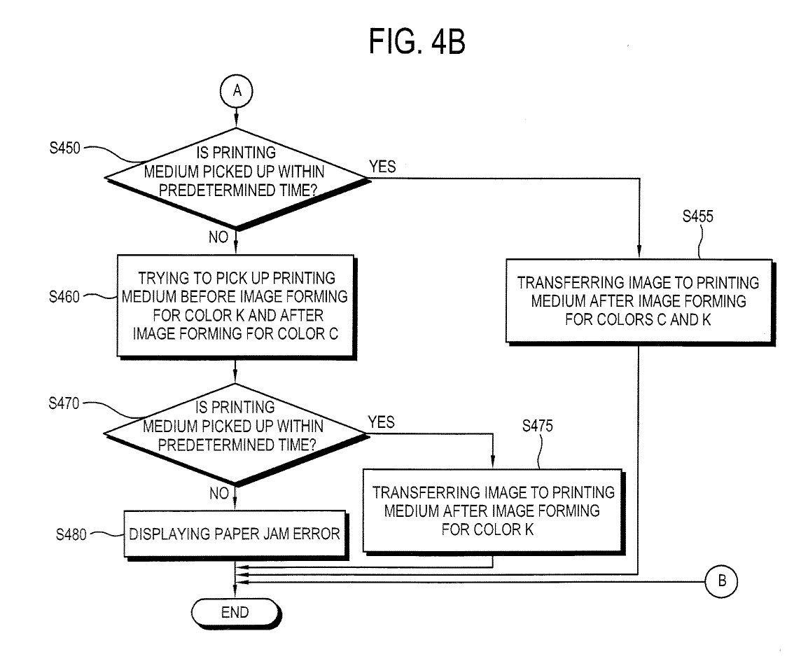

Hereinafter, an image forming method of the image forming apparatus 100 according to another exemplary embodiment of the present general inventive concept will be described with reference to FIGS. 4A and 4B.

Referring to FIGS. 1, 2, 4A and 4B, a printing command is inputted at operation S410, and then, the controller 130 controls the pickup roller 120 to try to pick up a printing medium before image forming for the color M and after image forming for the color Y at operation S420.

Then, the controller 130 determines whether or not the printing medium is picked up within a predetermined time at operation S430. If it is determined that the printing medium is picked up, the controller 130 controls the image forming part 130 to form images corresponding to the colors M, C and K to form a color image, and then, the color image is transferred to the printing medium at operation S435.

If it is determined that the printing medium is not picked up within the predetermined time, the controller 130 controls the pickup roller 120 to try to re-pick up the printing medium before image forming for the color C and after the image forming for the color M at operation S440.

Then, the controller 130 determines whether or not the printing medium is picked up within the predetermined time at operation S450. If it is determined that the printing medium is picked up, image forming for the colors C and K is completed, and then, the image is transferred to the printing medium at operation S455.

If it is determined that the printing medium is not picked up within the predetermined time, the controller 130 controls the pickup roller 120 to re-pick up the printing medium before image forming for the color K and after image forming for the color C at operation S460.

Then, the controller 130 determines whether or not the printing medium is re-picked up within a predetermined time at operation S470. If it is determined that the printing medium is picked up, image forming for the color K is completed, and then, the image is transferred to the printing medium at operation S475.

If it is determined that the printing medium is not picked up within the predetermined time, the controller 130 displays a paper jam error at operation S480.

In this way, it is possible to increase the number of trying to re-pick up the printing medium, thereby minimizing probabilities of the paper jam error.

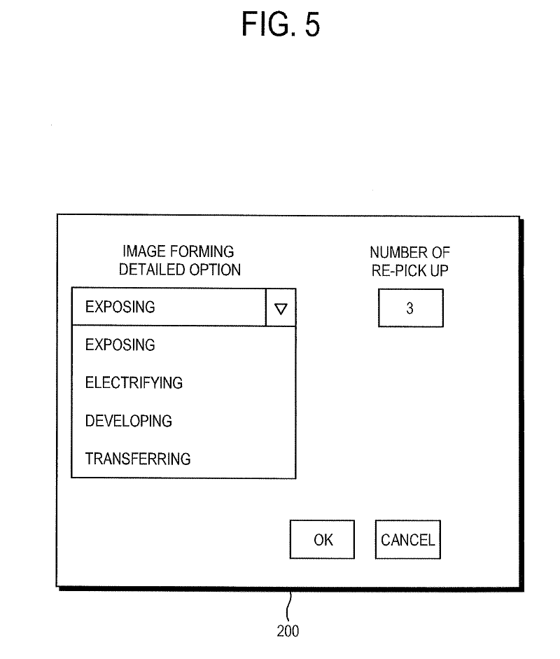

FIG. 5 illustrates a user interface 200 of the image forming apparatus 100 according to the present embodiment. As illustrated in FIG. 5, through the user interface 200 may be inputted detailed options for image forming by the image forming part 110. Thus, it is possible to control the pickup roller 120 not to pick up the printing medium during the image forming process.

Further, through the user interface 200 may be inputted the number of re-picking up the printing medium by a user. For example, if a user selects the number of re-pickup into three, the controller 130 controls the pickup roller 120 to try to pick up the printing medium until the intermediate transfer medium 30 idly rotates after image forming for all the colors is completed.

The user interface 200 may be displayed on the image forming apparatus 100. Alternatively, the user interface 200 may be provided from a driver of the image forming apparatus 100 or from an application for use in writing a document.

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

As described above, according to the present general inventive concept, it is possible to try to pick up a printing medium while an image forming part does not form an image, thereby minimizing the jitter phenomenon.

Further, it is possible to minimize noises which a user may feel due to driving of a pickup roller.

Furthermore, it is possible to try to pick up a printing medium even after image forming is completed.

Although a few exemplary embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An image forming method of an image forming apparatus comprising an image forming part which forms a color image on a printing medium, the method comprising:
forming an image corresponding to a first color among a plurality of colors;
performing a process to pick up the printing medium after image forming for the first color is completed; and
forming an image corresponding to a second color among the plurality of colors after performing the process to pick up the printing medium.

2. The image forming method of claim 1, wherein:
the image forming part comprises a photosensitive body and an intermediate transfer medium; and
the image forming comprises exposing the photosensitive body, electrifying a surface of the photosensitive body, developing an electrostatic latent image formed on the photosensitive body, and transferring the developed image onto the intermediate transfer medium.

3. The image forming method of claim 1, wherein the performing the process to pick up the printing medium comprises performing another process to re-pick up the printing medium after the image forming for the second color is completed, if the printing medium is not picked up.

4. The image forming method of claim 3, wherein the performing the process to pick up the printing medium comprises performing another process to re-pick up the printing medium, if the printing medium is not picked up after the image forming for all the plurality of colors is completed.

5. The image forming method of claim 4, wherein the performing the another process to re-pick up the printing medium comprises stopping cleaning the image during performing the another process to re-pick up the printing medium.

6. The image forming method of claim 4, wherein the intermediate transfer medium idly rotates during performing the another process to re-pick up the printing medium.

7. The image forming method of claim 4, wherein the number of the re-picking up may be selected by a user.

8. The image forming method of claim 7, wherein the number of the re-picking up may be selected through a user interface of at least one of the image forming apparatus, a driver of the image forming apparatus, and an application for use in writing a document.

9. The image forming method of claim 1, wherein the plurality of colors comprises yellow (Y), magenta (M), cyan (C) and black (K).

10. The image forming method of claim 1, wherein the image forming comprises forming the image in a multi-pass method.

11. An image forming method of forming a color image on a printing medium, the method comprising:
forming an image corresponding to a first color among a plurality of colors;
forming an image corresponding to a second color among the plurality of colors; and
performing a process to pick up the printing medium in a non-image section between the image forming for the first color and the image forming for the second color.

12. An image forming apparatus, comprising:
an image forming part to form a color image on a printing medium;
a pickup roller to pick up the printing medium; and
a controller to control the pickup roller to perform a process to pick up the printing medium if image forming for a first color among a plurality of colors is completed, and controls the image forming part to form an image corresponding to a second color among the plurality of colors after performing the process to pick up the printing medium.

13. The image forming apparatus of claim 12, wherein:
the image forming part comprises a light scan unit, a photosensitive body and an intermediate transfer medium; and
the image forming comprises exposing the photosensitive body by the light scan unit, electrifying a surface of the photosensitive body, developing an electrostatic latent image formed on the photosensitive body, and transferring the developed image to the intermediate transfer medium.

14. The image forming apparatus of claim 12, wherein the controller controls the pickup roller to perform another process to re-pick up the printing medium after image forming for the second color is completed, if the printing medium is not picked up.

15. The image forming apparatus of claim 14, wherein the controller controls the pickup roller to perform another process to re-pick up the printing medium, if the printing medium is not picked up after image forming for all the plurality of colors is completed.

16. The image forming apparatus of claim 15, further comprising:
a cleaning member to clean the image,
wherein the controller controls the cleaning member not to clean the image during trying to re-pick up the printing medium.

17. The image forming apparatus of claim 15, wherein the intermediate transfer medium idly rotates during trying to re-pick up the printing medium.

18. The image forming apparatus of claim 12, wherein the plurality of colors comprises yellow (Y), magenta (M), cyan (C) and black (K).

19. The image forming apparatus of claim 12, wherein the image forming part forms the image in a multi pass method.

20. An image forming apparatus, comprising:
an image forming part to form a color image on a printing medium;
a pickup roller to pick up the printing medium; and
a controller to control the pickup roller to perform a process to pick up the printing medium in a non-image section between image forming for a first color among a plurality of colors and image forming for a second color among the plurality of colors.

21. An image forming apparatus comprising:
an image forming part to form a plurality of color images to form a multi color image;
a pickup unit to pick up a printing medium; and
a controller to control the pickup unit not to pick up the printing medium when the image forming part forms each of the plurality of color images.

22. The image forming apparatus of claim 21, further comprising:
a feeding roller to feed the picked up printing medium,
wherein the controller controls the feeding roller not to feed the picked up printing medium until the multi color image is formed from the plurality of color images.

23. The image forming apparatus of claim 21, wherein the controller controls the pickup unit to repeat a process to pick up the printing medium between image forming processes of the image forming part.
